(19) United States
(12) Patent Application Publication
(10) Pub. No.: US 2026/0042963 A1
(43) Pub. Date: Feb. 12, 2026

(54) METHOD FOR ENHANCING SABKHA SOIL BEARING CAPACITY USING GEOPOLYMER INJECTION UNDER EXISTING STRUCTURES

(71) Applicant: KING SAUD UNIVERSITY, Riyadh (SA)

(72) Inventors: WAGDI MOHAMMED HAMID, Riyadh (SA); AHMED MOHAMED ALNUAIM, Riyadh (SA); ABDULHAFIZ OMAR ALSHENAWY, Riyadh (SA)

(21) Appl. No.: 18/799,210

(22) Filed: Aug. 9, 2024

(51) Int. Cl. C09K 17/12; C04B 14/04; C04B 18/08; C04B 18/12; C04B 22/06; C04B 28/00; C04B 111/00; E02D 3/12

(52) U.S. Cl. CPC C09K 17/12; C04B 14/045; C04B 18/08; C04B 18/12; C04B 22/062; C04B 28/006; E02D 3/12; C04B 2111/00732

(57) ABSTRACT

A method for increasing soil bearing capacity provides a sustainable and effective solution for the stabilization of saline soil, such as sabkha soil. The present method involves preparing a geopolymer grout including alkali-activated aluminosilicate materials and injecting the geopolymer grout into the soil. In an embodiment, the geopolymer grout can be injected into the soil while the soil is supporting structures thereon.

### BACKGROUND

### 1. Field

The present disclosure relates to improving sabkha soil bearing capacity and, more particularly, to a method for stabilizing sabkha soil by injecting a geopolymer grout including alkali-activated aluminosilicate materials into the soil under existing structures.

### 2. Description of the Related Art

Sabkha is an Arabic word used to describe salt-encrusted flat land covered with sand, sediment, or clay. Roughly 33% of the Earth's land surface is situated within the arid climatic region. This region exhibits a notable lack of water precipitation in relation to the potential moisture loss caused by evaporation. Previous studies have identified a number of geotechnical challenges caused by the chemical and physical properties of sabkha soil. The geotechnical challenges related to sabkha soil include, for example, compressibility and volumetric change, low strength, deterioration of building materials, low bearing capacity, increased surface cracking, liquefaction resulting from dynamic loading, and swell potential. Accordingly, the presence of sabkha soil, particularly in close contact with the surface, presents inherent difficulties. To address these challenges, it is essential to employ soil improvement methods in order to enhance the soil's bearing capacity and minimize differential settlement.

The selection of an appropriate improvement technique is influenced by various factors, including the type of sabkha soil, the characteristics of the project, the type and extent of improvement required, the cost involved, and the available construction time. Various techniques have been utilized to enhance the characteristics of weak sabkha soils, encompassing mechanical stabilization methods like preloading, vibro-flotation, stone columns, and dynamic compaction. Additionally, chemical stabilization has been employed through the incorporation of additives such as cement, e.g., Ordinary Portland Cement (OPC), lime, or cement kiln dust. Another approach involves the utilization of geotextiles for stabilization purposes.

The stabilization of weak soil is a crucial issue in geotechnical engineering, especially for sabkha soil. Sabkha soil has low strength, high compressibility, and high salt content, which make it unsuitable for supporting structures without proper treatment. The conventional stabilization methods for weak soil mainly involve stabilizing the soil using mix and compact method with chemical additives, such as Portland cement, lime, fly ash (FA), or geopolymer. However, these methods have several limitations. Many conventional methods, for example, are only applicable for new sites and cannot be used to stabilize soil under existing structures, require a large amount of chemical additives, which increase the cost and environmental impact of the stabilization process, consume a high amount of energy during the production of the additives, especially Portland cement and lime which emits a high amount of CO₂, and/or are not efficient or durable enough to achieve the desired improvement of the sabkha soil properties.

Thus, a method for stabilizing soil, solving the aforementioned problems is desired.

### SUMMARY

The present subject matter relates to a method for stabilizing soil that provides a sustainable and effective solution for the stabilization of saline soil, such as sabkha soil, thereby improving the bearing capacity of the soil. The present method involves preparing a geopolymer grout including alkali-activated aluminosilicate materials and injecting the geopolymer grout into the soil. In an embodiment, the geopolymer grout can be injected into the soil while the soil is supporting structures thereon.

Injecting the geopolymer grout into the soil can confer many advantages in addition to improving the ultimate bearing capacity (UBC) of the soil. For example, the geopolymer grout can be applied to soils having structures existing thereon, without disturbing the structures. Additionally, the geopolymer grout can be formed using waste materials that are abundant and cheap. Thus, the geopolymer grout can reduce the environmental impact of the soil stabilization process by minimizing the use of cement and other harmful chemicals.

The geopolymer grout can adapt to the unique behavior of sabkha soil, preventing or reducing adverse effects of sabkha soil, including inconsistent compressibility which can cause differential settlement and severe cracks or damage to structures. Other issues associated with the sabkha soil are low unconfined compressive strength of surficial sabkha layers, which can be further weakened by exposure to water, and a diminished bearing capacity upon interaction with fresh water. This can be due to the dissolution of cementing materials and a reduction in shear strength.

These and other features of the present subject matter will become readily apparent upon further review of the following specification.

### BRIEF DESCRIPTION OF DRAWINGS

FIG. 1 is a graph showing particle size distribution of saline sabkha soil, FA, and MT.

FIG. 2 is a schematic illustration of the physical model experiments.

FIGS. 3A-3B show the setup of the physical model experiments.

FIGS. 4A-4C are schematic diagrams of the (4A) physical model apparatus, (4B) the container of untreated sabkha soil, and (4C) the container of sabkha soil treated using the injection method.

FIGS. 5A-5B are schematic diagrams showing a plan view of locations of injected geopolymer below circular shallow foundation in two cases: (5A) Nᵢ=1, and (5B) Nᵢ=4.

FIGS. 6A-6D are schematic diagrams showing preparation of geopolymer grout and the syringe used to inject the geopolymer grout into the soil.

FIGS. 7A-7B are graphs showing load displacement behavior of treated sabkha soil using the injection method for (7A) Nᵢ=1 and (7B) Nᵢ=4.

FIG. 8 is a graph showing UBC of treated sabkha soil using the injection method.

FIG. 9 is a graph showing results of the sensitivity analysis for mesh type.

FIGS. 10A-10B are diagrams of the finite elemental model (FEM) for untreated sabkha soil model showing (10A) dimensions of the model; and (10B) the system's mesh.

FIGS. 11A-11D show the FEM simulation for the treatment of sabkha soil using the injection method for (11A and 11C) Ni=1; and (11B and 11D) Ni=4.

FIG. 12 shows load-displacement curves of untreated sabkha soil for experimental and numerical analysis

FIGS. 13A-13B show load-displacement curves of geopolymer treated sabkha soil (injection method) for experimental and numerical analysis.

FIGS. 14A-14D are graphs showing displacement ratio versus pressure for geopolymer treated sabkha soil using injection method at different numbers of injection points and different injection depths for (4A) Ni=1, (4B) Ni=2, (4C) Ni=3, and (4D) Ni=4.

FIG. 15 is a graph showing UBC of geopolymer treated sabkha soil using injection method at different numbers of injection points and different injection depths.

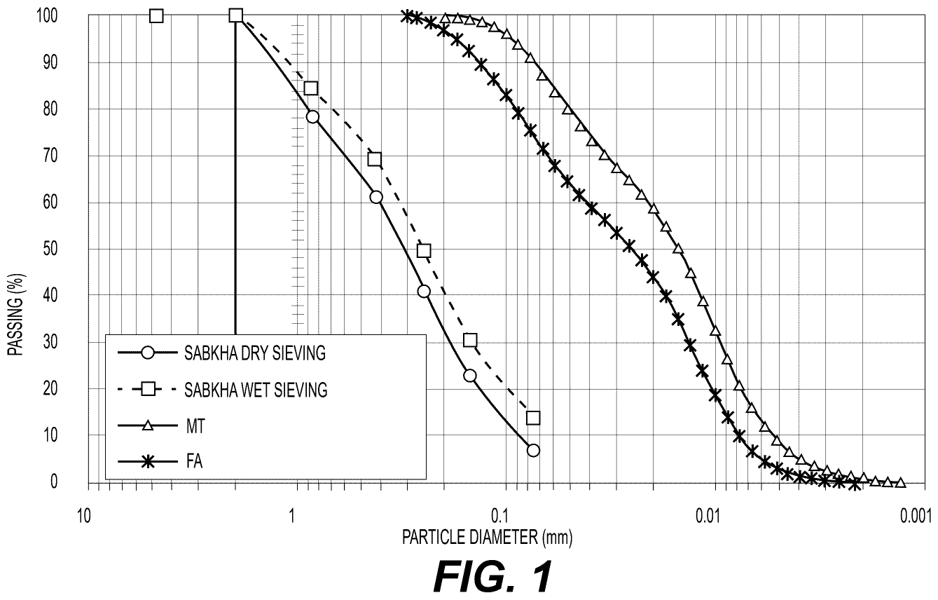

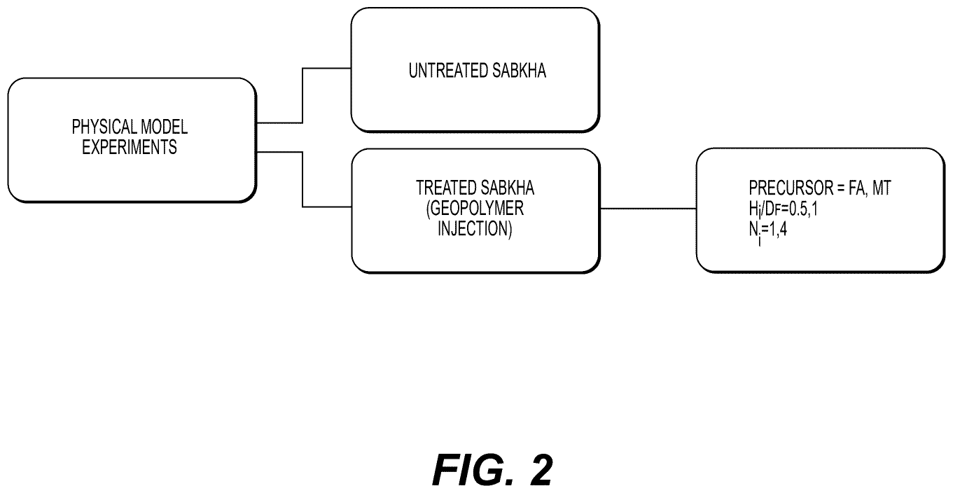

### DETAILED DESCRIPTION OF THE PREFERRED EMBODIMENTS

The following definitions are provided for the purpose of understanding the present subject matter and for construing the appended patent claims.

### Definitions

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not.

It will be understood by those skilled in the art with respect to any chemical group containing one or more substituents that such groups are not intended to introduce any substitution or substitution patterns that are sterically impractical and/or physically non-feasible.

Unless defined otherwise, all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

Throughout the application, descriptions of various embodiments use “comprising” language. However, it will be understood by one of skill in the art, that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

The present subject matter relates to a method for stabilizing soil that provides a sustainable and effective solution for the stabilization of saline soil, such as sabkha soil. In an embodiment, the present method includes preparing a geopolymer grout including alkali-activated aluminosilicate materials and injecting the geopolymer grout into the soil. In an embodiment, the geopolymer grout can be injected into the soil while the soil is supporting structures thereon. The geopolymer grout is efficient and durable and can achieve a significant improvement in the UBC of sabkha soil.

When silica and alumina are dissolved in an alkaline liquid, artificial cementitious materials are created that improve the characteristics of the soil. In contrast to the hydration response of OPC-soil mixtures, this procedure, known as geo-polymerization, provides a more sustainable method of stabilizing soil.

In an embodiment, the geopolymer grout is rich in silica and alumina. In an embodiment, the geopolymer grout includes one or more dry precursor materials selected from the group consisting of FA, mine tailings (MT), slag, and metakaolin. In an embodiment, the geopolymer grout comprises a dry precursor material selected from the group consisting of FA and MT. In an embodiment, the MT include at least about 50% silica, e.g., about 54%, silica and at least about 7% alumina, e.g., about 9%, alumina. In an embodiment, the FA includes at least about 50% silica, e.g., about 58% silica, and at least about 20% alumina, e.g., about 27%, alumina.

In an embodiment, the geopolymer grout is prepared by combining the dry precursor material with an alkaline activator solution and mixing the precursor material until a homogenous grout is achieved. In an embodiment, the dry precursor material can be combined with the alkaline activator solution at a ratio of 1.25. In an embodiment, the alkaline activator solution can include sodium silicate (SS) and sodium hydroxide (SH). In an embodiment, the alkaline activator solution can include a 2:1 ratio of SS and SH.

In an embodiment, the geopolymer grout can be injected into the soil at various depths and locations. In an embodiment, the geopolymer grout can be injected in a plurality of locations in the soil, for example one, two, three, or four, different locations in the soil. In an embodiment, the geopolymer grout can be injected into the soil at depths (Hᵢ) ranging from about 0.5 of the foundation width/diameter (D_{f}) to about 2 times of the foundation width/diameter (Df) into the soil, e.g., the Hi/Df ranges from 0.5 to 2 into the soil. In an embodiment, the geopolymer grout is injected into the soil using an injector, e.g., such as a syringe. Following injection, the treated soil can be allowed to cure for about seven days at ambient temperature, e.g., about 23° C., prior to loading additional structures thereon.

Table 1 below shows the composition of exemplary samples of FA and MT.

TABLE 1

| | Elemental Oxide | | | | | | | | | | | | | |
|---|---|---|---|---|---|---|---|---|---|---|---|---|---|---|
| | Na₂O | MgO | Al₂O₃ | SiO₂ | P₂O₅ | SO₃ | K₂O | CaO | TiO₂ | MnO | Fe₂O₃ | Cl | CuO | LOI |
| MT | 0.29 | 8.45 | 9.25 | 54.20 | 0.04 | 5.11 | 0.12 | 3.37 | 0.10 | 0.15 | 13.48 | 0.14 | 0.19 | 5.08 |
| FA | 0.26 | 0.71 | 27.78 | 58.20 | 0.48 | 0.70 | 1.51 | 3.95 | 1.62 | 0.03 | 4.15 | 0.12 | 0.01 | 0.3 |
| Sabkha | 1.41 | 6.52 | 1.30 | 16.81 | 0.03 | 5.07 | 0.33 | 40.43 | 0.07 | 0.01 | 0.50 | 1.66 | — | 25.8 |

Table 1 below shows the composition of exemplary samples of FA and MT.

The following examples illustrate the present teachings.

### EXAMPLES

### Materials

Saline sabkha soil samples were collected at the Ras-Al-Ghar site in Saudi Arabia's Eastern Province. To adequately address the geotechnical design considerations related to the lower portion of the soil stratum, it was critical to remove the uppermost 0.3 meters of subsoil before obtaining the specimens. The water table was observed to be situated at a depth of 0.5 meters beneath the surface, whereas the collected specimens displayed a white color. The collection of specimens was conducted manually during the winter season.

The grain size distribution of the sabkha soil, FA, and MT are depicted in Error! Reference source not found. The dry and wet sieving methodologies for sabkha soil were employed to determine the percentages of soil particles that effectively passed through a #200 sieve, resulting in recorded values of 6.8% and 13.2% respectively. The observed variations in grain size distribution may be related to the soluble mineral structure of sabkha soil, which shows notable variation after washing. Water possesses a tendency to solubilize salts that are found within the connections of soil particles. As a result, the wet approach leads to a higher volume of particles that successfully move through the sieve in comparison to the dry method. The results obtained from both sieving techniques showed no significant variations in comparison to the results of prior studies. Table 1 presents a comprehensive summary of the categorization and physical characteristics associated with saline sabkha soil.

TABLE 1
Sabkha soil classification and physical characteristics.

| | Properties | | | | | | | | |
|---|---|---|---|---|---|---|---|---|---|
| | | Passing | | | | | | | |
| | Specific | through | | | | | | | |
| Sieving | gravity, | #200 | D₁₀ | D₃₀ | D₆₀ | | | | |
| type | Gs | (%) | (mm) | (mm) | (mm) | Cᵤ | C_{c} | USCS* | AASHTO** |
| Dry | 2.78 | 6.786 | 0.09 | 0.19 | 0.42 | 4.67 | 0.96 | SP-SM | A-3 |
| sieving | | | | | | | | | |
| Wet | 2.78 | 13.748 | 0.06 | 0.15 | 0.31 | 5.17 | 1.21 | SM | A-2-4 |
| sieving | | | | | | | | | |

*Unified Soil Classification System
**American Association of State Highway and Transportation Officials

The process of geopolymer synthesis includes the utilization of two distinct precursors, namely copper MT and FA. The MT sample was collected from a copper mining site located approximately 120 kilometers southeast of Medina, Saudi Arabia. The MT samples were obtained as moist solids, with a natural moisture content of 29%.

Following the completion of the drying process, the MT aggregates experienced a procedure involving crushing and sieving, using a #10 sieve. This procedure was implemented in order to mitigate the effect of particle accumulating and ensure full utilization of all of the MT material available.

The FA class F, which was imported from India, was utilized as a precursor during the geopolymer synthesis procedure. able 2 displays the chemical composition of the sabkha soil, MT, and FA, ascertained via XRF analysis. The analysis revealed that silica and alumina were the predominant elements in MT and FA, whereas calcium and silica were the main elements in sabkha soil. However, it was noted that when the silica concentration rose, the pozzolanic activity and geopolymerization rate of the MT, FA, and sabkha soils showed an increasing trend.

TABLE 2
XRF analysis of FA, MT, and sabkha soil

| | Elemental Oxide | | | | | | | | | | | | | |
|---|---|---|---|---|---|---|---|---|---|---|---|---|---|---|
| | Na₂O | MgO | Al₂O₃ | SiO₂ | P₂O₅ | SO₃ | K₂O | CaO | TiO₂ | MnO | Fe₂O₃ | Cl | CuO | LOI |
| MT | 0.29 | 8.45 | 9.25 | 54.20 | 0.04 | 5.11 | 0.12 | 3.37 | 0.10 | 0.15 | 13.48 | 0.14 | 0.19 | 5.08 |
| FA | 0.26 | 0.71 | 27.78 | 58.20 | 0.48 | 0.70 | 1.51 | 3.95 | 1.62 | 0.03 | 4.15 | 0.12 | 0.01 | 0.3 |
| Sabkha | 1.41 | 6.52 | 1.30 | 16.81 | 0.03 | 5.07 | 0.33 | 40.43 | 0.07 | 0.01 | 0.50 | 1.66 | — | 25.8 |

### Example 1

### Physical Model Experiments

The behavior of foundation-soil-superstructure systems can be effectively studied in a controlled environment through use of physical model experiments. These models offer several advantages over other methods. They provide complete control over the model's details and the geotechnical properties of the soil utilized in the testing. Additionally, they reduce the costs and materials required for constructing and testing the models. Small-scale testing necessitates less soil, a smaller container, shorter foundation dimensions, and less time than full-scale testing. Furthermore, it reveals the overall trend of the model's behavior. Error! Reference source not found. shows a schematic illustration of the physical model experiments.

### Dimensions and Boundary Effects

The vertical stress of the soil decreases with depth due to friction between the container walls and the soil grains. To eliminate side-wall friction, the height-to-diameter ratio of a container is suggested to be equal to or less than one. As such, the ratio of container height to diameter in this research was 0.85 (less than 1.0). To reduce the impact of boundary conditions, the boundary was increased by five to eight times the size of the foundation. Consequently, the diameter of the container was eight times that of the foundation model.

To minimize internal scale effects between a penetrating item and the test soil, Vipulanandan et al. (1989) recommends maintaining a ratio of 50 or higher between the diameter of the foundation and the effective-soil particle-size diameter. The tested soil had a Dio of 0.09 mm and a foundation width of 50 mm, resulting in a ratio of foundation width to mean particle size that falls within the required conditions.

### Set-Up of the Physical Model

As depicted in Error! Reference source not found. A-3B, a steel frame was utilized to support and ensure the verticality of the actuator unit employed to apply vertical static loads to the foundation. The steel frame comprised four columns, six major transverse beams, and one secondary beam, all of which possess channel cross-sections. Given the considerable weight of the actuator unit and the consideration of static loads during the operation test, each column was affixed to a base plate with dimensions of 400×400×8 mm. The actuator unit was mounted on the channel beam section, which was subsequently welded to the main transverse beam.

### Preparation of Tested Soil

In the physical modeling, two stages of testing were employed: one with untreated sabkha soil and another with sabkha soil treated using the injection approach. At the onset of testing, untreated sabkha soil was prepared by combining a specified quantity of dry sabkha soil with a predetermined amount of tap water. The weight of dry sabkha soil was estimated based on the volume of the container and the soil's density, while the weight of water was calculated based on the weight of sabkha soil and its water content (ω_{c}) at the saturation state using the following equation:

$${ω}_{c} = \frac{es}{{G}_{s}} \qquad ( 1 )$$

where s is the degree of saturation, e is the void ratio, and Gₛ is the specific gravity of the sabkha soil. It is important to note that when sabkha soil is moist, it loses its strength and becomes more susceptible to collapse. As such, in this step, the sabkha soil was simulated in its worst scenario.

The wet soil mixture was formed in 6 layers, each of which had a certain weight of wet soil and was 5 cm thick. Subsequently, layers of wet soil were added until the highest part of the container was reached. The process was intended to sufficiently saturate the sabkha soil by submerging the soil for 24 hours in enough water to cover it. After soaking for 24 hours, the extra water that had been covering the soil was removed.

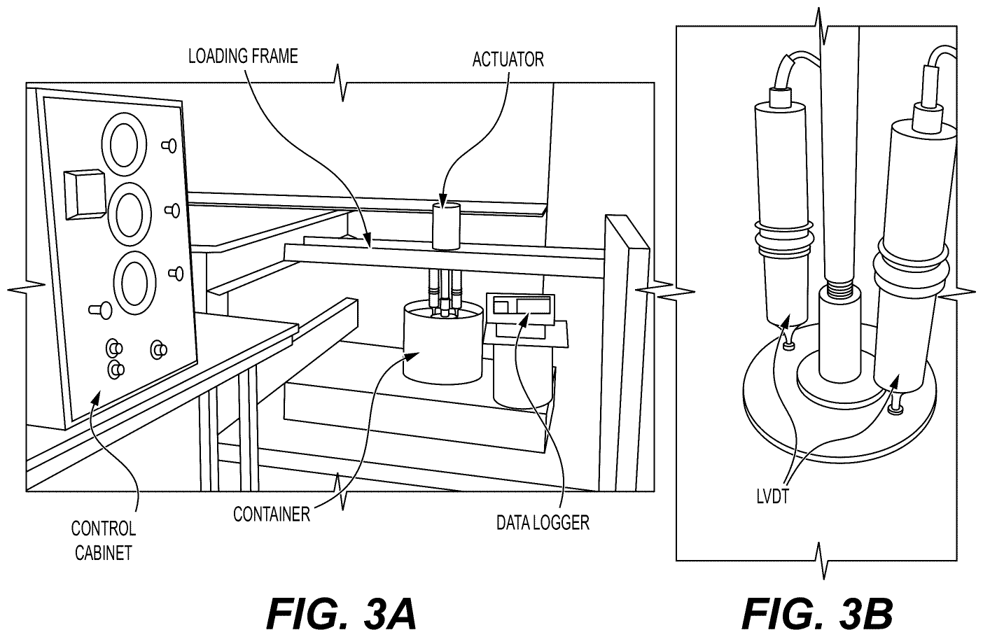

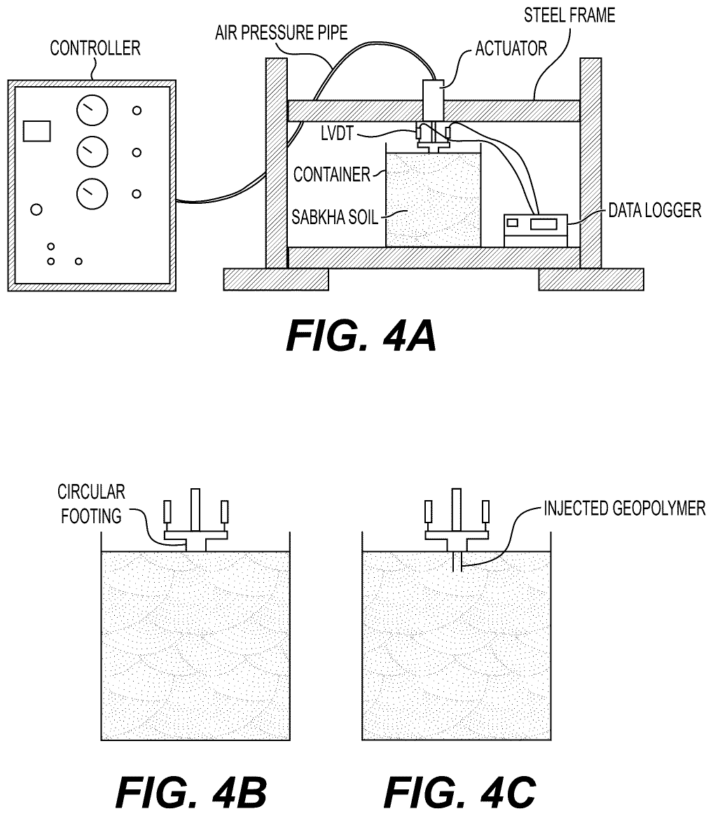

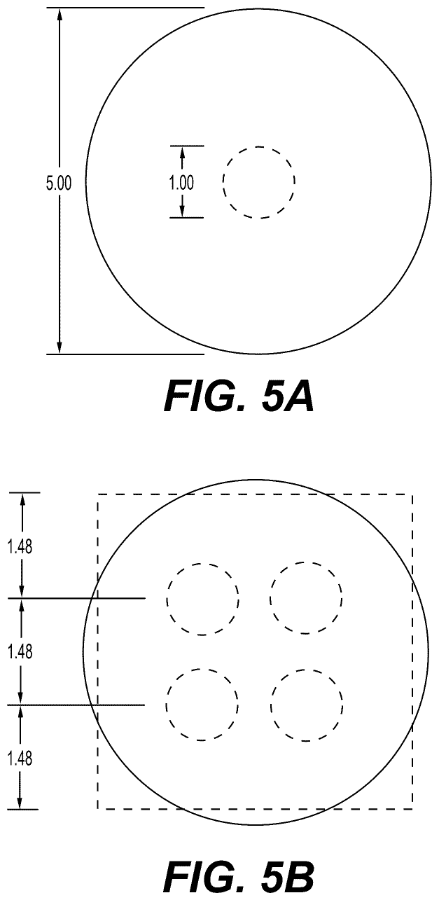

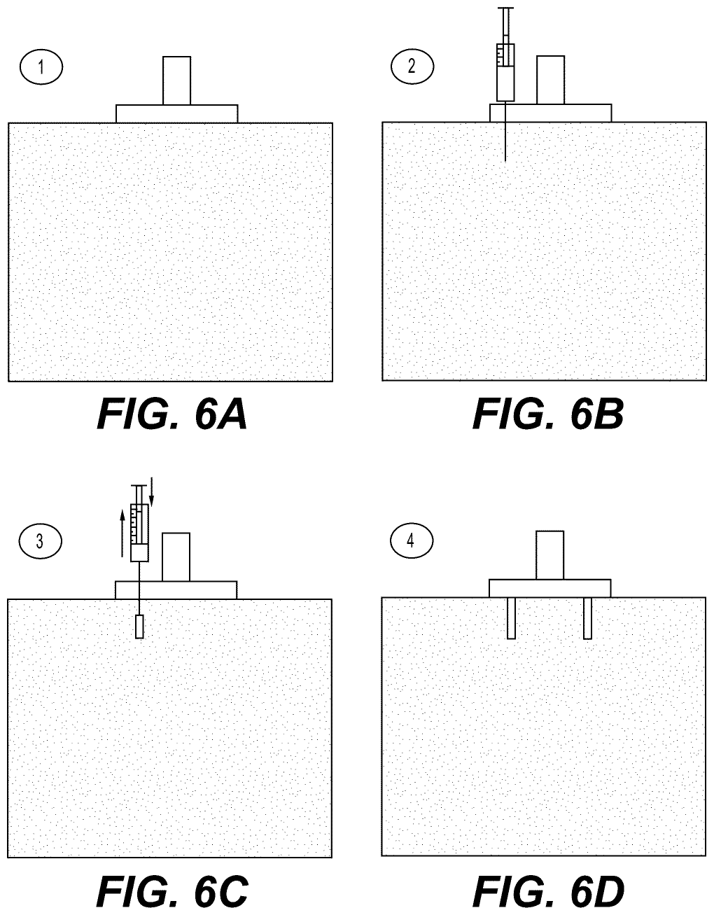

As depicted in FIGS. 3A-3B, in order to determine the bearing capacity of untreated sabkha soil, the foundation was installed on top of the soil and two LVDTs were attached in order to measure the average displacement during loading. In the case of soil treated with the injection procedure, dried sabkha soil was placed into the container, and geopolymer was injected using a syringe into the soil. The treated soil was then allowed to set and solidify for a week before the soaking phase started. The circular foundation and LVDTs were then all setup, and their connectivity to the data logger was confirmed before starting the loading process (FIGS. 4A-4C). FIGS. 6A-6D depict the prepared geopolymer grout and the syringe utilized for injecting the geopolymer into the soil. FIGS. 4A-4C show a schematic diagram for the experimental program. FIGS. 5A-5B show a plan view of injected geopolymer locations below a circular shallow foundation in two cases: (a) Nᵢ=1, and (b) Nᵢ=4.

### Preparation of Geopolymer Injection-Treated Sabkha Soil

To assess the efficacy of geopolymer injection treatment, geopolymer grout was synthesized by combining a predetermined quantity of dry precursor (either FA or MT) with an alkaline solution at a ratio of 1.25. This ratio was selected based on previous research by Koutník et al. (2020), which demonstrated that it provides sufficient strength while maintaining an appropriate viscosity for injection via syringe. The alkaline activator solution was prepared using a 2:1 ratio of SS and SH. The molarity of SH was 8 M.

The precursor and alkaline solution were thoroughly mixed until a homogenous grout was achieved. Subsequently, the grout was injected into the soil at various depths and locations using a syringe with a 3 mm diameter. The investigated factors for the injection treatment technique included the type of precursor (FA or MT), injection locations (1 and 4), and injection depths (25 mm and 50 mm). Following injection, the treated soil was allowed to cure for a minimum of 7 days at ambient temperature (23° C.) prior to conducting loading tests. FIGS. 6A-6D show the steps involved in the geopolymer injection method under foundation.

### Loading System and Test Procedure

The loading system comprised air-powered testing equipment, including a control cabinet and actuator unit, as well as a container, loading frame, load cell, and data logger, as shown in FIGS. 4A-4C. Static loading was applied to the foundation model using an air-powered test system consisting of a control cabinet and actuator unit. The actuator unit included an air cylinder, shuttle valve, pilot air supply, main air supply, and MAC valve. Activation of the air cylinder was achieved via either the MAC valve or the static load line. The shuttle valve regulated airflow to the air cylinder. The loading intensity was adjusted using the control cabinet of the loading system. A data logger and a load cell with a capacity of 10 kN were utilized to determine the loading values per division. The actuator applied the loading, and the load values were monitored in the data logger.

The loading procedure was conducted on a circular foundation situated on both untreated and geopolymer-treated soil to assess the efficacy of the injection treatment method in augmenting the bearing capacity, and to compare it with that of untreated sabkha soil. Prior to commencing the loading procedure, all sensors connected to the data logger were calibrated to zero reading. The loading process was incrementally increased by 0.5 divisions using the controller cabinet, and the load remained constant after each increment until displacement ceased and the rate of deformation was equal to or less than 0.01 mm/min. The final phase of loading was terminated when either the treated soil failed or when the displacement reached approximately 25 to 35 mm.

Subsequently, data pertaining to loading, displacements, and stresses were extracted from the data logger and subjected to analysis. The bearing capacity was measured from the load-displacement curve, with the (UBC) being obtained using the slope tangent approach. This entailed calculating the bearing capacity from the intersection of the tangents of the initial linear component and the steeper linear portion following failure on the load-displacement curve. However, in certain cases where the curve exhibited a linear increase until high displacements, this approach was not applicable. In such instances, an alternative method was employed, which involved taking the bearing capacity as the value corresponding to a displacement of 25 mm.

### Load-Displacement Behavior

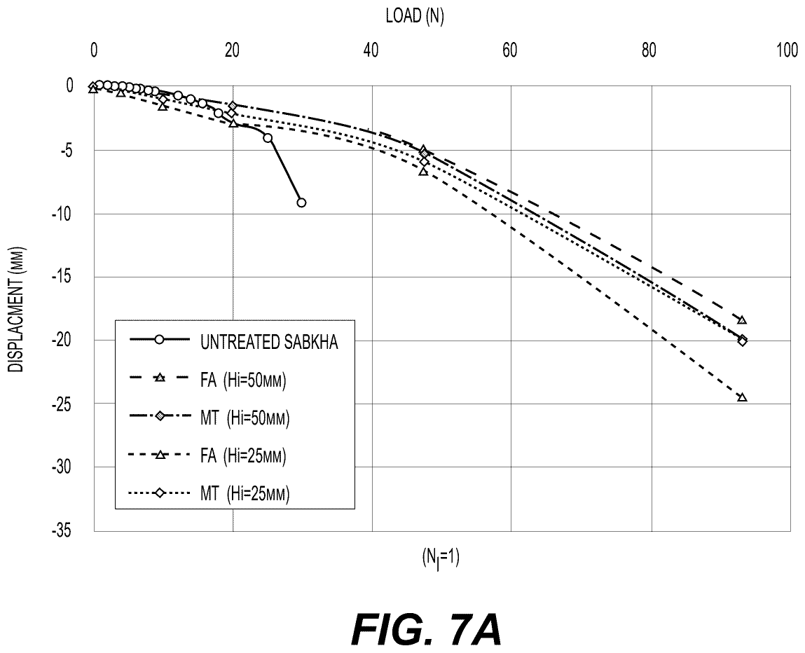

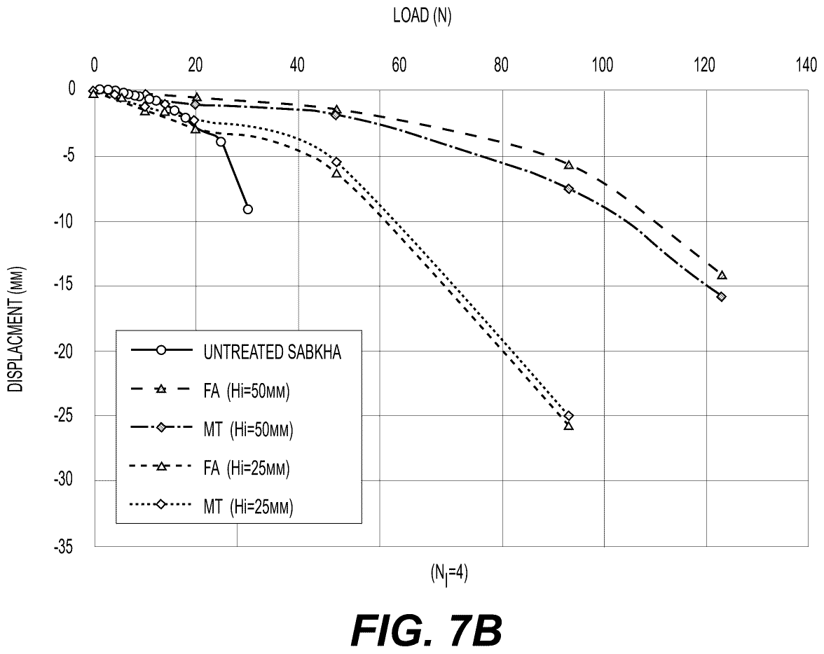

The injection method was employed to enhance the properties of sabkha soil and increase its bearing capacity. Geopolymer based on FA and MT was utilized as a grouting material that was injected into sabkha soil using a syringe at different locations and depths. After a curing period of 7 days, loading tests were conducted to investigate the load-displacement behavior of the treated soil and compare it with the results of the untreated sabkha soil. FIGS. 7A-7B illustrate the load-displacement behavior of untreated and treated sabkha soil using the injection method. The results demonstrate that treating sabkha soil using the geopolymer injection method can be a useful approach to enhance the strength of the soil and decrease displacement. It was found that increasing the number of injections from 1 to 4 significantly increased the strength of sabkha soil. Additionally, increasing injection depth by using Hᵢ/D_{f}=1 instead of 0.5 showed a significant increase in load-bearing capacity when using numbers of injections of 4. However, using 1 injection did not show any further improvement when increasing injection depth.

### Ultimate Bearing Capacity

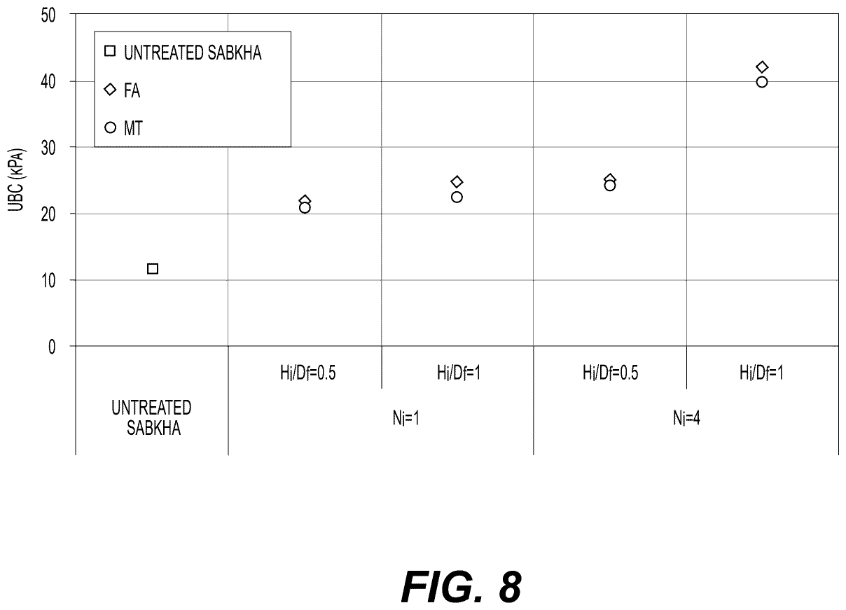

FIG. 8 shows the results of the UBC of sabkha soil using the injection method at different numbers of injections points (1 and 4) and different injection depths (Hᵢ/D_{f}=0.5 and 1). The results indicate that at Hᵢ/D_{f}=1, increasing the number of injections can improve the bearing capacity of sabkha soil. For example, increasing the number of injections from 1 to 4 increased the UBC by 70% and 77% for FA- and MT-based geopolymers, respectively. Meanwhile, using Hᵢ/D_{f}=0.5 for different numbers of injections (1, and 4) increased the UBC by a range of 79% to 118% compared to the UBC of untreated sabkha soil. Also, higher improvement values were obtained by using Hᵢ/D_{f}=1 and injection numbers of 4, which show an improvement ratio of UBC compared to untreated soil by 265%. Based on these results, it is recommended to use four injections and Hᵢ/D_{f} not less than one to obtain the best results from both strength and economical points of view.

The injection method offers a viable solution for enhancing the bearing capacity of sabkha soil, particularly for pre-existing structures that were constructed on untreated sabkha soil. This method eliminates the need for demolishing the building and applying a stabilization method prior to reconstruction. The injection method can achieve a significant degree of improvement by stabilizing sabkha soil with geopolymer solution. However, while the injection method can be used efficiently to stabilize sabkha soil, it has some disadvantages. For example, it can be challenging to ensure that the injected geopolymer grouting is distributed evenly below the foundation.

### Example 2

### Numerical Study

The Finite Element Method (FEM) is a powerful and versatile modeling technique that can be applied to a wide range of engineering problems. In this study, numerical analysis was conducted on loading experiments involving untreated sabkha and geopolymer-treated sabkha, with the aim of validating experimental work and providing an alternative means of examining load transfer mechanisms under various conditions. Numerical analysis offers a high degree of flexibility in modifying model parameters and inputs, allowing for the exploration of a broader range of potential outcomes. This enables the analysis of soil behavior under a variety of conditions, which would be difficult to achieve using physical models. Additionally, numerical analysis allows for the observation of behavior in a multitude of situations that were not possible during experimental work. In cases where instruments may be damaged during concrete pouring or strain gauge installation, numerical analysis can be used to calculate values. A numerical investigation was conducted using FEM by comparing data from small-scale physical model experiments with computed results from numerical models developed using the finite element software PLAXIS 3D.

FEM involves partitioning the domain of interest into a finite number of smaller subdomains or elements. The behavior of the system within each element is approximated using simple mathematical functions, and the equations governing the system are solved for each element. The solutions for all elements are then combined to obtain an approximate solution for the entire domain. This approach allows for a detailed analysis of complex systems and provides valuable insights into their behavior.

### Constitutive Models and Soil Parameters

The Hardening Soil (HS) model was utilized to simulate the behavior of untreated sabkha soil. The HS model is an advanced model capable of simulating the behavior of various soil types, including both soft and stiff soils. Due to its simplicity, the Mohr-Coulomb (MC) model has been used in previous studies to simulate untreated sabkha soil. However, the MC model displays certain limitations that could potentially lead to discrepancies between the predicted soil behavior and the actual observed behavior in reality. The HS model is an advanced soil model that shows enhanced capabilities in generating a soil response that is more representative of actual conditions, particularly in relation to non-linear behavior, stress dependence, and inelasticity. The HS model demonstrates superiority over the MC model due to its employment of a hyperbolic stress-strain curve, as opposed to a bi-linear curve, and its capacity to control stress level dependency. In contrast, the MC model necessitates the user to select a constant value for Young's modulus, despite the fact that this parameter is contingent upon the level of stress in actual soils. One notable limitation of the MC model relates to its assumption that the stiffness modulus (Eᵤᵣ) associated with soil unloading-reloading is equivalent to the stiffness (E₅₀). observed during soil loading. In actuality, soils commonly demonstrate a significantly higher modulus when subjected to unloading-reloading conditions as compared to loading conditions. In comparison to the loading stiffness, the unloading-reloading stiffness may be 2-5 times greater. This suggests that when employed for evaluating excavation problems, the MC model has the potential to overestimate soil heave in an impractical manner. Therefore, it is crucial to assess the stress levels existing in the soil and employ this data to determine suitable stiffness values.

Based on the default configurations, it's recommended that the Eᵤᵣ value for different soil types should be around three times the value of E₅₀, whereas the E_{oed} value is approximately equal to E₅₀. Nonetheless, it's important to note that very soft or very stiff soils may lead to varying user-adjustable ratios of E_{oed}/E₅₀. Table 3 displays the values of parameters used in the HS model.

TABLE 3
Values of parameters used in HS model.

| Parameters of Untreated | | |
|---|---|---|
| sabkha | Value | Unit |
| Model type | HS model | — |
| ${E}_{50}^{ref}$ | 8000 | (kN/m²) |
| ${E}_{oed}^{ref}$ | 8000 | (kN/m²) |
| ${E}_{ur}^{ref}$ | 24000 | (kN/m²) |
| νᵤᵣ | 0.2 | — |
| Power (m) | 0.75 | — |
| ${c}_{ref}^{′}$ | 0 | (kN/m²) |
| φ′ | 35° | — |
| ψ | 5° | — |
| Rᵢₙₜₑᵣ | 0.67 | — |

### Element Type Selection

Tetrahedral elements are one of the three-dimensional elements, along with hexahedral and wedge elements. The first-order tetrahedral element has four nodes located at the ends of its six edges and four faces. The second-order tetrahedral element, also known as the quadratic tetrahedral element, has ten nodes: four at the ends of the edges and six at the midpoints of the edges. This ten-node tetrahedral element uses a complete quadratic function to interpolate the displacement field across the nodal values of the element. This element is available in the PLAXIS 3D program. The injected geopolymer grouting was simulated as an embedded beam. In the PLAXIS 3D software, the embedded beam element is represented as a line element comprising three nodes. This element is capable of intersecting with a tetrahedral element, which consists of ten nodes and serves to model the soil.

### Soil-Structure Interfaces Modeling

In the PLAXIS software, which employs the FEM, soil-structure interactions can be simulated using “zero-thickness” interface elements. These elements utilize a strength/stiffness reduction factor on the soil that is adjacent to the interface. The key parameter for the interface element is Rᵢₙₜₑᵣ, which denotes the strength of the interface element as a percentage of the shear strength of the adjacent soil. The values of interface properties in PLAXIS can be directly established using a strength/stiffness reduction factor (Rᵢₙₜₑᵣ≤1.0), with a default value of Rᵢₙₜₑᵣ=1.0 indicating a fully bonded interface. In this study, the interface element was employed to model the interaction between untreated sabkha soil and the foundation. For sabkha soil, Rᵢₙₜₑᵣ values between 0.61 and 0.83 have been suggested by prior investigations.

### Load Application

PLAXIS provides both load-controlled and displacement-controlled options. Therefore, it is possible to apply either a direct load or a prescribed displacement. To examine the performance of the loading test on the foundation, a load-controlled approach was employed in the PLAXIS 3D model. This involved the application of a concentrated load (point load) at the top center of the plate. The applied load was executed in stages that were identical to those employed in the small-scale physical model.

### Mesh Size and Refinement

The meshing in PLAXIS 3D was defined by utilizing two significant parameters, namely the relative element size factor (rₑ) and the average element size (Lₑ). The parameter rₑ values for the predefined element have been assigned as follows: 2.0 for very coarse, 1.5 for coarse, 1.0 for medium, 0.7 for fine, and 0.5 for very fine, respectively. Similarly, the element size values allocated for the predefined element include: 0.08546 m for very coarse, 0.0641 m for coarse, 0.04273 m for medium, 0.02991 m for fine, and 0.02137 m for very fine, respectively.

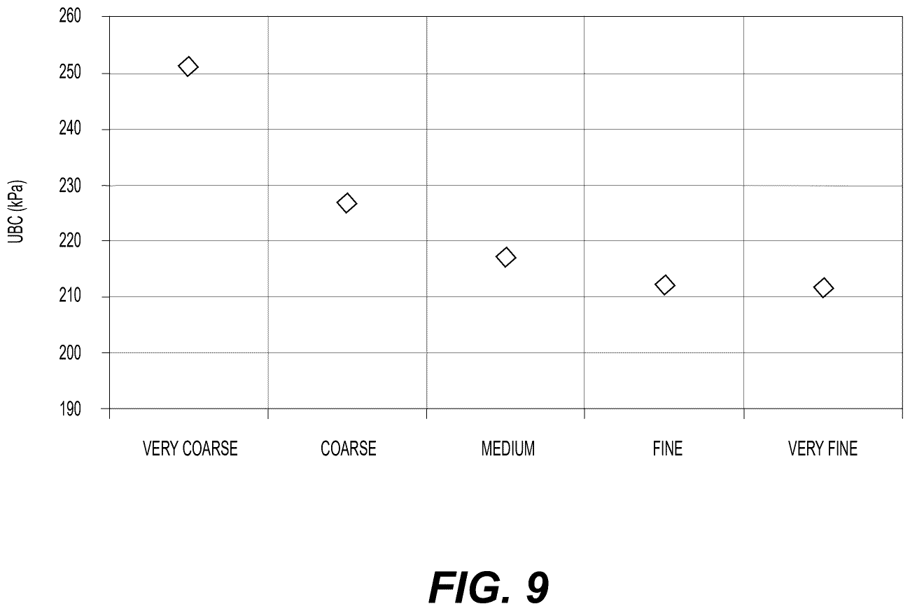

In this study, a sensitivity analysis was conducted to determine the most appropriate element distribution mesh (i.e., very coarse, coarse, medium, fine, or very fine). As shown in FIG. 9, there is an inverse relationship between the mesh size and the UBC value. This indicates that the solution becomes more accurate as the mesh is refined. Nonetheless, it is essential to recognize that there is a limit beyond which further refinement may not result in appreciable changes to the solution. In contrast to using a Very Fine mesh, using a Fine mesh type provides the optimal balance between accuracy and decreasing the time of running the mode.

### Domain Dimension

In order to mitigate the influence of boundary conditions on FEM outcomes, it was proposed that the boundary distance for the model in a static analysis should be no less than five times the structure's dimensions. Nonetheless, Alsanabani (2021) performed a sensitivity analysis concerning domain size/foundation diameters of 2.5, 5, 7.5, 10, 12.5, and 15. For each domain, the foundation's settlement due to static loading was assessed. The foundation was represented as a plate element possessing the linear elasticity of concrete material. Based on the relationship between the foundation's settlement and the ratio of boundary domain to foundation diameter, it was determined that the boundary effect becomes negligible once the boundary reaches a distance of five times the foundation's diameter. Consequently, in this study, a model with dimensions equivalent to nine times those of the foundation model was employed. In PLAXIS 3D, it is important to mention that there are five distinct element sizes: very coarse, coarse, medium, fine, and very fine. During the meshing process, the diagonal distance is divided into a predetermined number of subdivisions. As a result, the size of fine and coarse elements varies for each domain

### Model Calibration and Validation

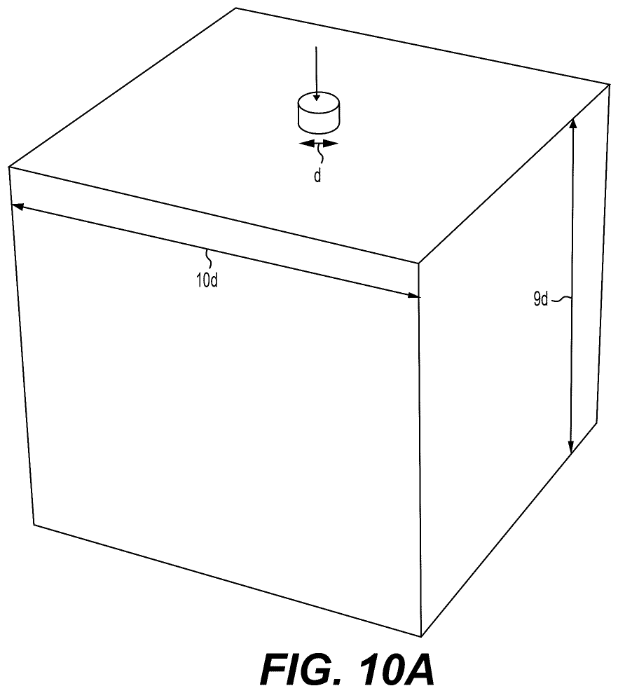

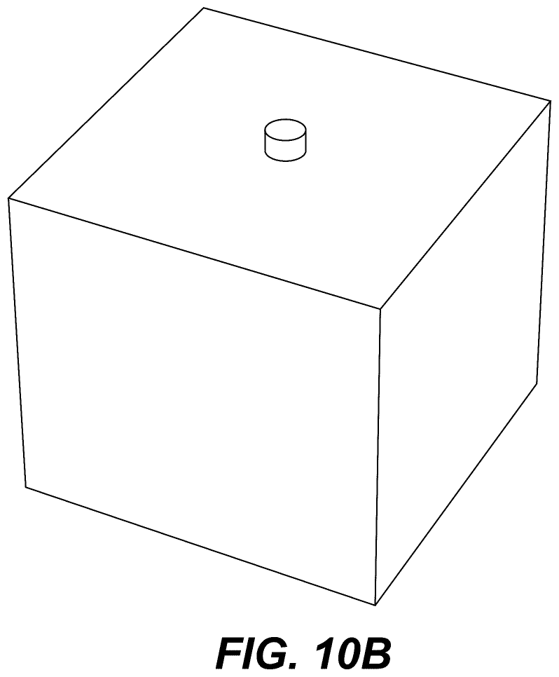

The process of calibrating the numerical model entailed multiple iterations of adjusting the soil and interface elements' stiffness and strength properties within certain limits to enhance the alignment with the experimental response. Eventually, the parameters listed in Table 3 were employed. FIGS. 10A-10B shows the configuration of FEM for the untreated sabkha soil model and the system's mesh. The determination of the modulus of elasticity E₅₀ for untreated sabkha soil was obtained from the triaxial testing results of sabkha soil, as reported by Alsanabani (2021). Eᵣₘ is set to 3E₅₀ by default. With these values, a reasonable match was achieved with the experimental test results, as shown in FIG. 12.

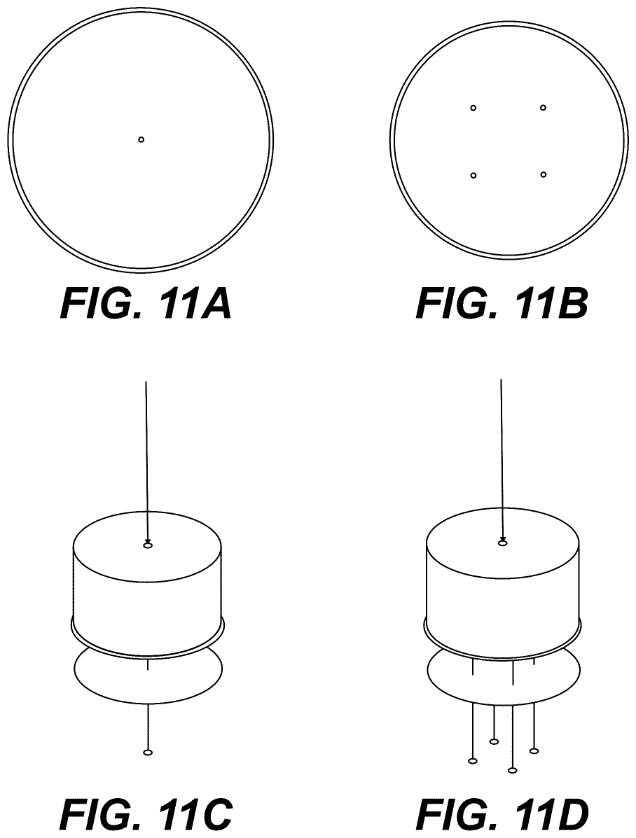

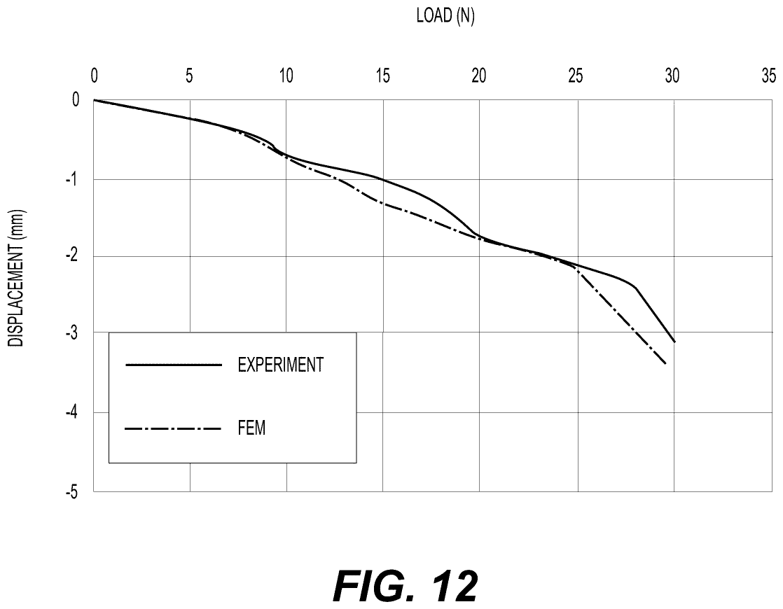

However, for sabkha soil treated using the injection method, it appears challenging to accurately represent the injected grouting. This is due to the fact that the real process of injection involves the grouting material passing through voids in a non-homogeneous manner. As such, using an embedded beam option to simulate the injection process was considered by the author to be the most applicable method for numerically representing the injected geopolymer grouting material. FIGS. 11A-11D illustrate the FEM simulation of treatment of sabkha soil using injection method.

### Model Validation

The validation procedure for a numerical model simulation is crucial as it verifies the accuracy of the model's representation of the real system. The ultimate objective of this procedure is to produce a model that is both accurate and trustworthy. Validation ensures that the model is constructed for a specific purpose or set of objectives and that its validity is determined for that purpose. This can help to improve the quality of the model, minimize costs, and prevent overfitting and underfitting. By validating a model, researchers and users can have confidence in the accuracy of the model and its results, enabling them to use it to solve problems and make informed decisions.

The validity of the model was ascertained through a comparison of the load-settlement curves obtained from the physical model of geopolymer-treated sabkha soil, utilizing the injection method, with those derived from the FEM model under static loading conditions. Given that the load-settlement behavior is predominantly influenced by the arrangement and configurations of the geopolymer injection treatment, rather than the type of the precursor, the numerical analysis was conducted based on soil treated with FA-based geopolymer. Subsequently, the results were compared to the corresponding values obtained from the experiment.

In the development of the numerical model, ten-node tetrahedron elements were employed to simulate the untreated sabkha soil and the foundation. At the foundation-soil interfaces, interface elements were utilized, with their strength being equivalent to a percentage of the adjacent soil shear strength. The untreated sabkha soil model comprised a system of 19723 elements and 30432 nodes. In contrast, the geopolymer-treated sabkha soil model exhibited variations in the number of elements and nodes depending on the treatment method employed. For the model using injection method, the number of elements ranged from 19449 to 19837 and the number of nodes ranged from 30066 to 30703.

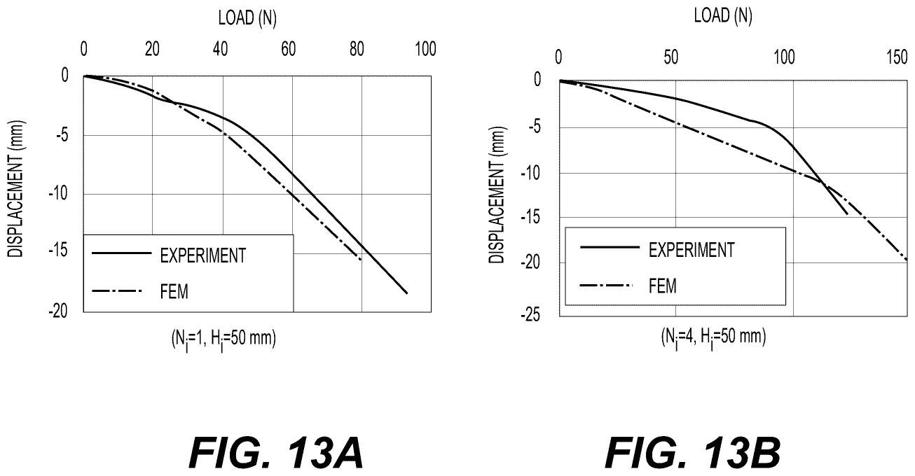

The PLAXIS program facilitated the execution of the finite element model in phases to simulate geostatic equilibrium, the construction sequence, and the incremental application of vertical loads. A load was applied at a node located at the center of the model foundation, commencing at 1 N and increasing in increments similar to the applied load in physical model testing until reaching a failure load. A comparison between the load-displacement curves obtained from the experimental and numerical FEM models is presented in FIG. 13A and FIG. 13B. The data reveals a high degree of agreement between the two curves, indicating that the FEM model accurately simulates the load-displacement behavior of the system.

### Parametric Study

The objective of this parametric study was to assess the influence of specific geometric parameters on the mechanical behavior of sabkha soil treated with geopolymer. A Parametric study was executed utilizing the previously calibrated and verified Finite Element model (Table 4). The parameters under investigation include the number of injection points (Nᵢ), and the depth of injection (Hᵢ). Through systematic variation of these parameters, the study aimed to show their relative importance in determining the bearing capacity and load-settlement response of the soil. The findings of this analysis will provide valuable insights for practical applications and inform future research.

TABLE 4
Parametric study using injection method at different numbers
of injection points and different injection depths.

| Parametric study No. | Nᵢ | Hᵢ (mm) | Hᵢ/D_{f} |
|---|---|---|---|
| 1 | 1 | 25 | 0.5 |
| 2 | 1 | 50 | 1 |
| 3 | 1 | 75 | 1.5 |
| 4 | 1 | 100 | 2 |
| 5 | 2 | 25 | 0.5 |
| 6 | 2 | 50 | 1 |
| 7 | 2 | 75 | 1.5 |
| 8 | 2 | 100 | 2 |
| 9 | 3 | 25 | 0.5 |
| 10 | 3 | 50 | 1 |
| 11 | 3 | 75 | 1.5 |
| 12 | 3 | 100 | 2 |
| 13 | 4 | 25 | 0.5 |
| 14 | 4 | 50 | 1 |
| 15 | 4 | 75 | 1.5 |
| 16 | 4 | 100 | 2 |

### Effect of Numbers of Injection Points and Depth of Injection

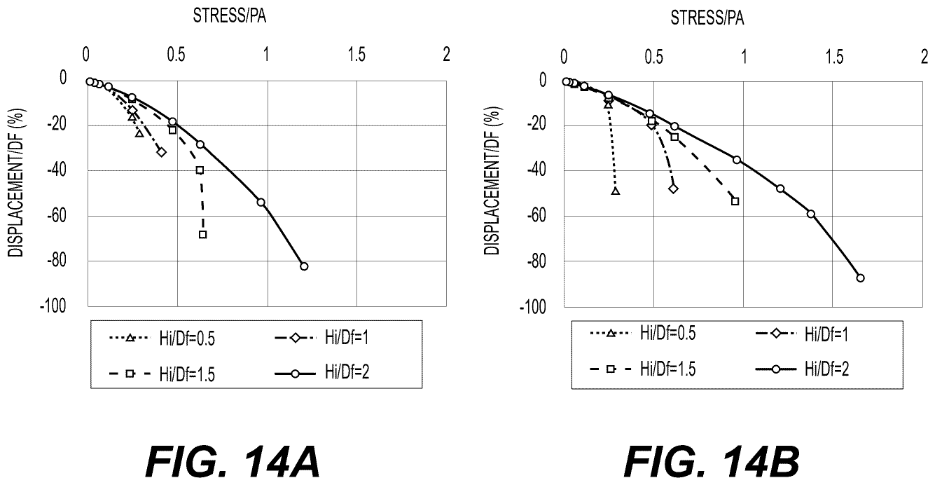

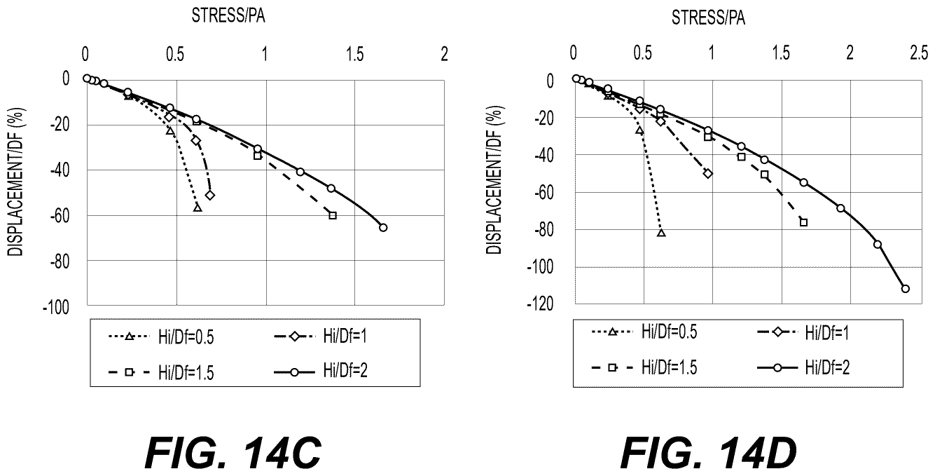

The present study investigated the relationship between the displacement ratio and stress normalized by atmospheric pressure for geopolymer-treated sabkha soil using the injection method. The investigation was carried out at varying numbers of injection points (Nᵢ=1, 2, 3, and 4) and different injection depths (Hᵢ/D_{f}=0.5, 1, 1.5, and 2), and the results are presented in FIGS. 14A-14D. The findings reveal that the injection method is an effective means of improving the load-displacement behavior of sabkha soil. The number of injection points plays a crucial role in reducing deformation and enhancing the soil layer's stiffness and stability. Moreover, the injection depth significantly delays failure and enhances the bearing capacity of sabkha soil.

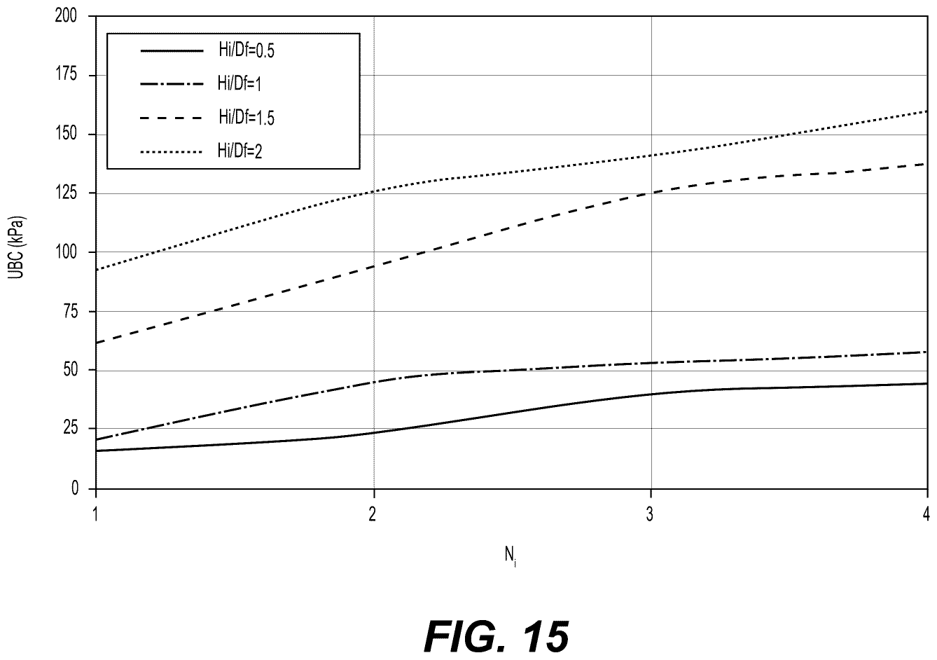

The UBC of sabkha soil treated with the injection method is presented in FIG. 15, at varying numbers of injection points and different injection depths. The results show that increasing the injection points leads to an increase in the UBC. For instance, at Nᵢ=1, 2, 3, and 4 and Hᵢ/D_{f}=2, the UBCs were 92.59, 126.09, 140.93, and 159.55 kPa, respectively. Additionally, with an increase in Hᵢ/D_{f} value, the UBC also increased. For example, with Nᵢ=4 and Hᵢ/D_{f}=0.5, 1, 1.5, and 2, the UBCs were 44.38, 97.28, 137.31, and 159.55 kPa, respectively. The findings of this study demonstrate that the bearing capacity of sabkha soil treated with the injection method can be notably improved through the accurate selection of the number of injection points and the depth of injection. Through the optimization of these parameters, it becomes feasible to significantly mitigate the tendency of sabkha soil to collapse and improve its stability for construction purposes.

The application of injection method to improve the mechanical characteristics of soil has been studied by several researchers. Wang et al., (2021) presented an experimental investigation into the stabilizing of silt soil utilizing permeable polyurethane via the injection method. A visual steady-pressure grouting test apparatus was constructed to examine the diffusion and reinforcement behavior of polyurethane in silt under varying pressure conditions, with a particular focus on the interaction mechanisms between the grout and soil body structure. The results of SEM-EDS and mercury intrusion tests demonstrated that the polyurethane had a substantial impact on the soil structure, effectively reducing its porosity and cementing soil particles, thereby enhancing the overall properties of the soil. Walter, (1999) investigated a simple and cost-effective fluid injection technique that utilizes a soil shearing mechanism to generate an enhanced flow regime within the soil. This enhanced flow regime facilitates greater accessibility to contaminants and enables the more effective application of conventional in situ treatment technologies across a wider range of soil conditions. The injection tests conducted as part of the study resulted in the formation of high permeability discontinuities within the soil surrounding the wellbore, indicating a marked improvement in soil properties.

It is to be understood that the method for increasing soil bearing capacity is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A method for enhancing sabkha soil bearing capacity, comprising:
preparing a geopolymer grout by combining one or more dry precursor materials selected from the group consisting of FA, MT, slag, and metakaolin with an alkaline activator solution, the dry precursor material including alumina and silica; and
injecting the geopolymer grout into the sabkha soil;
wherein the soil has at least one structure supported thereon; and
wherein the alkaline activator solution comprises a 2:1 ratio of SS and SH by weight.

2.-4. (canceled)

5. The method of claim 1, wherein the dry precursor material comprises at least about 50% by weight silica and at least about 7% by weight alumina.

6. The method of claim 1, wherein the dry precursor material comprises about 50% by weight silica and at least about 20% by weight alumina.

7. The method of claim 1, wherein the dry precursor material is combined with the alkaline activator solution at a ratio of 1.25 by weight.

8-9. (canceled)

10. The method of claim 1, wherein the geopolymer grout is injected into the soil at a depth ranging from about 0.5 times to 2 times the width or diameter of a foundation of at least one of the at least one structure.

11. The method of claim 1, wherein the geopolymer grout is injected into the soil using an injector, and the injection of the geopolymer grout occurs simultaneously with the withdrawal of the injector from the soil.

12. The method of claim 11, wherein the injector has a nozzle or outlet configured to dispense the geopolymer grout into the soil.

13. The method of claim 1, further comprising allowing the soil to cure after injection for about seven days at ambient temperatures.

14. A method for enhancing sabkha soil bearing capacity, comprising:
preparing a geopolymer grout by combining one or more dry precursor materials selected from the group consisting of FA, MT, slag, and metakaolin with an alkaline activator solution, the dry precursor material including alumina and silica; and
injecting the geopolymer grout into the sabkha soil;
wherein the alkaline activator solution comprises a 2:1 ratio of SS and SH by weight.

15. (canceled)

16. The method of claim 14, wherein the dry precursor material comprises at least about 50% by weight silica and at least about 7% by weight alumina.

17. The method of claim 14, wherein the dry precursor material comprises about 50% by weight silica and at least about 20% by weight alumina.

18. The method of claim 14, wherein the dry precursor material is combined with the alkaline activator solution at a ratio of 1.25 by weight.

19-20. (canceled)
